(19) United States
(12) Patent Application Publication
(10) Pub. No.: US 2023/0267857 A1
(43) Pub. Date: Aug. 24, 2023

(54) Sign System for First Responders

(71) Applicants: Brant Claussen, Cotati, CA (US); Joanie Claussen, Cotati, CA (US)

(72) Inventors: Brant Claussen, Cotati, CA (US); Joanie Claussen, Cotati, CA (US)

(21) Appl. No.: 18/110,322

(22) Filed: Feb. 15, 2023

Related U.S. Application Data
(60) Provisional application No. 63/268,216, filed on Feb. 18, 2022.

(51) Int. Cl. G09F 13/00; G09F 13/04

(52) U.S. Cl. CPC G09F 13/005; G09F 13/0418; G06K 19/06037

(57) ABSTRACT

A first responder sign system including highly visible reflective address signs that enable property owners to provide critical information about the property to first responders. The information is contained in icons that signify on-site features and conditions that enable first responders them to make an informed plan for engaging in any operations that might be required in the event of an emergency. The system may involve enterprise administration of communications via a system website hosted on a system server and downloadable apps that enable subscribers to log provide and update information about their property status and to receive notices and to enable first responders to rapidly obtain information about a subscriber property during emergency operations.

### CROSS REFERENCES TO RELATED APPLICATIONS

The present application claims the benefit of the filing date of U.S. Provisional Pat. Application Serial Number 63/268,216, filed Feb. 18, 2022, (Feb. 18, 2022), which application is incorporated in its entirety by reference herein.

### THE NAMES OR PARTIES TO A JOINT RESEARCH AGREEMENT

Not applicable.

### SEQUENCE LISTING

Not applicable.

### BACKGROUND OF THE INVENTION

Field of the Invention: The present invention relates most generally to signs, and more particularly to emergency signage systems, and still more particularly to emergency signage systems designed to provide first responders (firefighters, police, paramedics, EMT/EMS’s, equipment operators, support personnel, emergency management, etc.) with salient information regarding property features and characteristics that will aid them in performing operations to protect life, property, evidence, and the environment in the event of an emergency or evacuation order.

Background Discussion: Emergencies of nearly any kind, particularly largescale emergencies (floods, severe storms, fires) often put first responders into dangerous circumstances that force triaging a rescue effort. Time is of the essence in such efforts, and when occupied structures are either evacuated or the occupants are not available to provide first responders with information to assist in allocating rescue resources, the rescue effort is handicapped and guided only by the most obvious features in the immediate environment. This can put both the first responders and those in need of assistance in great but needless peril.

This is because rescue efforts in residential and commercial neighborhoods can be dramatically improved simply by providing first responders with information relevant to rescue efforts and decision-making in the rescue efforts. For instance, if upon arrival at an involved or potentially involved structure (house or building) the first responders are provided critical information concerning the people who occupy the property as well as the conditions and features of the property itself, decision-making is vastly more informed. For instance, if first responders arrive at an address and find a sign that rapidly indicates the presence of an ill or infirm resident, the presence or absence of pets or livestock, the existence of a large water source (e.g., a swimming pool, pond, or water storage tank), the location of water spigots, clearance for vehicles, dangerous conditions on the property (e.g., outdoor propane tanks), and the like, the first responders will know much more precisely how to prioritize their involvement in the rescue effort for that particular property.

To date, however, there is no known detailed first responder sign system that provides rapid and detailed indications of property conditions relevant to first responder operations.

### BRIEF SUMMARY OF THE INVENTION

The present invention is a sign system that provides property owners with a tool to communicate critical information to first responders in the case of an emergency. The system includes customizable, reflective address signs that meet or exceed local requirements. For purposes of brevity herein, the inventive signs as used in the sign system will be referred to by their proprietary name: fire safe sign. Details of the system are set out in the Detailed Description, below.

However, in its most essential aspect, in embodiments the present invention includes a customizable, highly visible reflective address sign that enables property owners to provide the most critical and salient information about the property to first responders. The signs use highly visible and easy to read icons that signify property features and conditions that provide first responders with information that enables them to make an informed plan for engaging in any operations that might be required in the event of an emergency. The sign, implemented even alone, provides numerous critical items of information that expedite and simplify search-and-rescue and other first responder operations.

Physically, the sign may display the pertinent information on a single side or both sides. They are preferably approximately 18×10.5 inches, though larger and smaller sizes are well within the scope of the invention. However, because visibility is critical, larger sizes are preferred. For durability, the signs are fabricated from sheet aluminum (e.g., 5052-H38) in gauges roughly comparable to standard street signs (e.g., 0.063 or 0.080 gauge), and they are provided with holes for mounting to a wood post, fence, tree, or wall, as well as a retroreflective adhesive plastic coating to enhance visibility in low-light conditions. In embodiments, the information may be printed on reflectorized decals, and as updated, a new decal sized to fit the sign dimensions may simply be placed over an outdated decal.

In other embodiments, the present invention may be implemented as a system that includes enterprise or agency-wide administration of communications via a system website hosted on a system server (on-site or in the cloud), having memory and executable code, that enables members, subscribers, registrants, and other kinds of system participants (hereinafter, collectively subscribers) to log in through a network connectable device and through a user interface to receive notifications, and to provide and update information about their property status for use by first responders. On the same system, first responders may access the system website and obtain information relating to the property of a particular system subscriber.

In embodiments, information about a particular property may be automatically GPS-activated and then visually presented to first responders via network connectable devices.

In embodiments, salient first responder information concerning a particular property may be accessed through a QR code incorporated into a property owner’s fire safe sign on the property, the code communicated to a central server, which then either transmits the information to first responders on site or makes the information available via a user interface. The use of other rapid information access techniques and protocols are also contemplated, including, for instance, license plate readers, near field communications, RFID, and the like, and each and all are within the scope of the invention.

The foregoing summary broadly sets out the more important features of the present invention so that the detailed description that follows may be better understood, and so that the present contributions to the art may be better appreciated. There are additional features of the invention that will be described in the detailed description of the preferred embodiments of the invention which will form the subject matter of the claims appended hereto.

Accordingly, before explaining the preferred embodiment of the disclosure in detail, it is to be understood that the disclosure is not limited in its application to the details of the construction and the arrangements set forth in the following description or illustrated in the drawings. The inventive system described herein is capable of other embodiments and of being practiced and carried out in various ways.

Those skilled in the art will appreciate that the conception, upon which this disclosure is based may readily be used as a basis for designing other structures, methods, and systems for carrying out the several purposes of the present invention. It is important, therefore, that the claims are regarded as including such equivalent constructions as far as they do not depart from the spirit and scope of the present invention. Rather, the fundamental aspects of the invention, along with the various features and structures that characterize the invention, are pointed out with particularity in the claims annexed to and forming a part of this disclosure. For a better understanding of the present invention, its advantages and the specific objects attained by its uses, reference should be made to the accompanying drawings and descriptive matter in which there are illustrated the preferred embodiment.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The invention will be better understood and objects other than those set forth above will become apparent when consideration is given to the following detailed description thereof. Such description makes reference to the annexed drawings wherein:

FIG. 1A is a schematic front view in elevation of a standard fire safe sign;

FIG. 1B is the same view showing use of a selectively removable evacuation sticker;

FIG. 2 is an embodiment of the fire safe sign using a single row of icons;

FIG. 3A is a schematic front view in elevation of a fire safe sign that includes a secure and encrypted QR code which may contain highly detailed information concerning property conditions, the code readable only by first responders;

FIG. 3B is the same view showing an alternative location for the QR code;

FIG. 3C is a view showing the embodiment of FIG. 2 with a QR code included;

FIG. 4 shows a fire safe sign having a vertical icon orientation;

FIG. 5 is a schematic screen shot showing a user interface through which a property owner may provide property and occupant information to local fire and rescue agencies and protection districts;

FIG. 6 is a schematic screen shot of a user interface for the first responders to see information entered by the owner of a residential or commercial address and to enter further select information concerning a particular residential or commercial address;

FIG. 7 is a schematic screen shot of a user interface for a first responder to enter property detail for addresses set up through the FIG. 6 screen; and

FIG. 8 is a schematic view of a map for an address entered into the system.

### DETAILED DESCRIPTION OF THE INVENTION: FIRE SAFE SIGNS

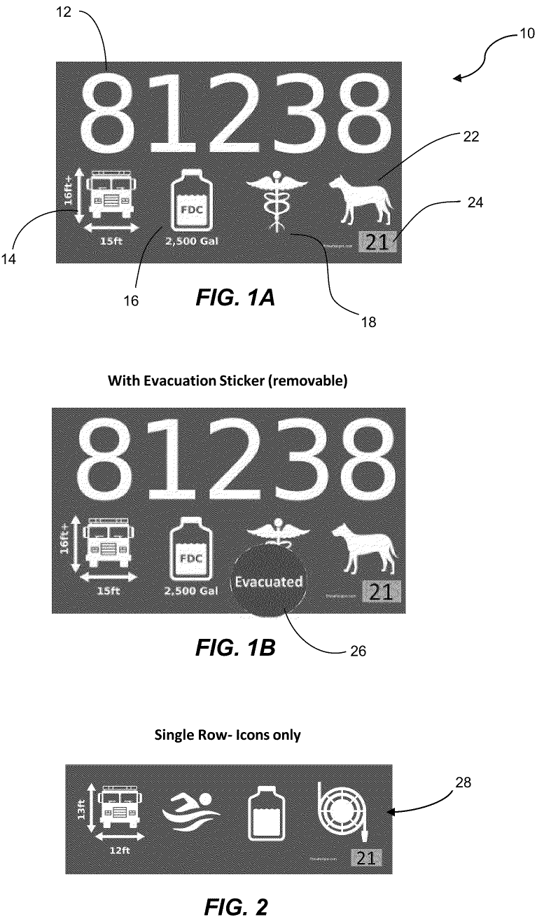

Looking first at FIG. 1A, it will be seen that the present invention is a communications system (known by the proprietary name of Fire Safe Sign) which includes means to alert first responders and others to constraints and assets a property has available in case of an emergency. The public-facing aspect is a customizable, reflective address sign 10 that contains multiple information elements, including: the street number of a property 12, the access clearances (height/width/turnaround) an emergency vehicle can expect when seeking emergency vehicle access to a property 14 (i.e., whether a emergency vehicle will be able to navigate a driveway or road on the property), water resources and sources available, including whether there is a Fire Department Connection on site 16, medical condition notifications for any individuals residing at the property having medical conditions 18, site hazards 20 (not shown in this view), and livestock, pets, or other animals that may be present on the property 22. The signs meet or exceed local and national standards and requirements for retroreflective sheeting set by the NFPA (National Fire Protection Association), e.g., ATMS 4956 07/MFPA. As is clear from the views, they are similar to street signs in their construction, but they provide numerous items of additional information useful to first responders. In the simplest terms, the signs enable first responders to do their job more quickly. And that saves lives and property.

The non-public-facing aspect of the system is online, based on a server-hosted website, either cloud-based or on site. The website is accessible and provides a downloadable app accessible through one or many of the commonly known current network connectable devices, such as mobile phones, laptops, tablet computers, personal data assistants, and desktop computers. Both property owners and first responders may access the system and employ a graphical user interface to interact with the system to provide, store, receive, and share important information in case of an emergency. The system is preferably implemented at the enterprise level as a subscription-based system, though if adopted region-wide in certain areas, it may be implemented and administered by local governmental agencies with users registering, subscribing, or otherwise signing up to receive services and provide property information for use by first responders in emergency situations.

Annual Sticker Renewal: To ensure that property information is current, a fire safe sign includes a well or other defined region on its surface for applying an annual renewal sticker 24, similar to renewal stickers for license plates evidencing a current vehicle registration. It is thus an annual color-coded sticker that indicates to first responders whether the information contained on the sign is current. The associated enterprise website collects information provided by the property owner to create these signs. This information may be used for other parts of the system.

Evacuated Sticker Notification: The system also has an evacuation notification feature. Subscribing or participating property owners receive “Evacuated” stickers 26, in embodiments comprising red, six inches round peel-and-stick stickers. With an annual or biennial renewal, they receive newly issued stickers [see FIG. 1B]. Evacuation stickers are to be placed on their fire safe sign in the event that they make a voluntary or mandatory evacuation of the property. The sticker is easily removed if for any reason it is no longer an accurate indication of property occupancy. The second part of the evacuation sticker feature is that a homeowner can update a system account via the internet to let first responders know they are evacuated. This will update the app in real time so that first responders sweeping an area can know which properties have been evacuated. A reminder will also be sent to the property owner to remove this notice once evacuation orders have been lifted.

An alternative embodiment of the sign, shown in FIG. 2, includes a single row of relevant property owner information 28 but excludes the street number of the property.

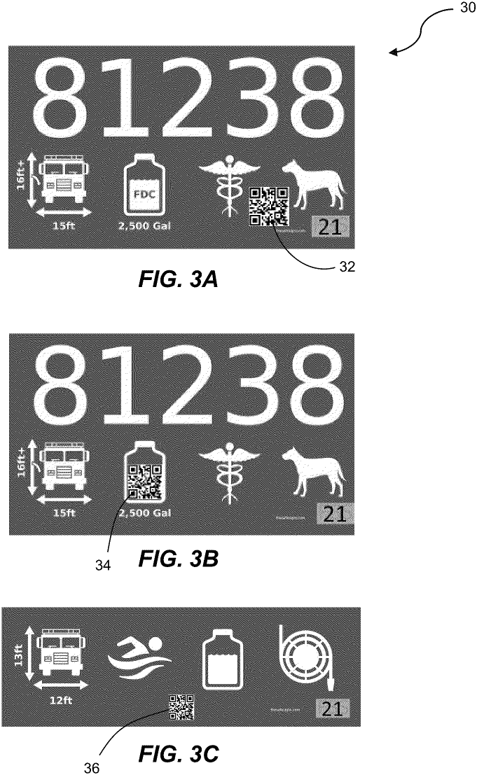

QR Codes: Looking now at FIGS. 3A-3C, in an alternative embodiment 30, the fire safe sign may include more detailed information available to first responders through a secured and encrypted QR code sticker 30. The QR code 32 on the sign enables first responders to find more detailed information about a specific property. In embodiments, the code 32 may be set apart from icons (FIG. 3A), incorporated into icons 34 (FIG. 3B), and may be included as an element in the single row iteration of the sign 36.

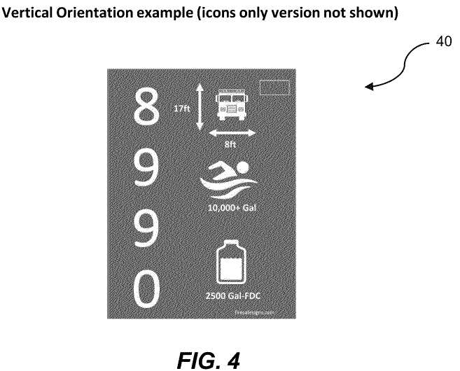

In yet another embodiment 40, the fire safe sign may provide the property information in a vertical format. [See FIG. 4] As those with skill will appreciate, an icon only embodiment may be provided were appropriate.

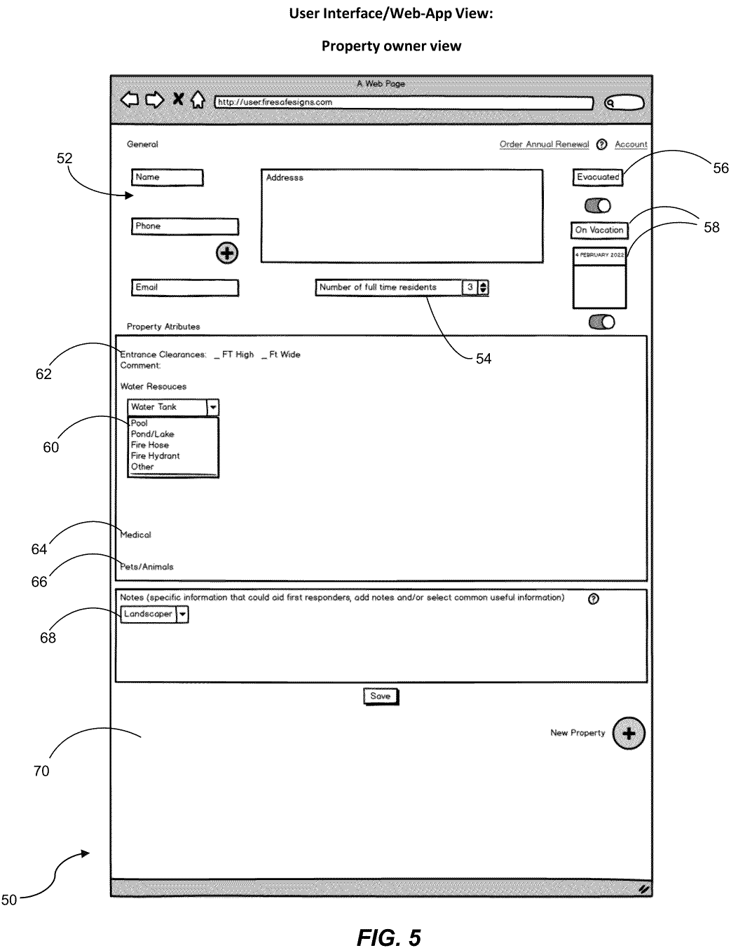

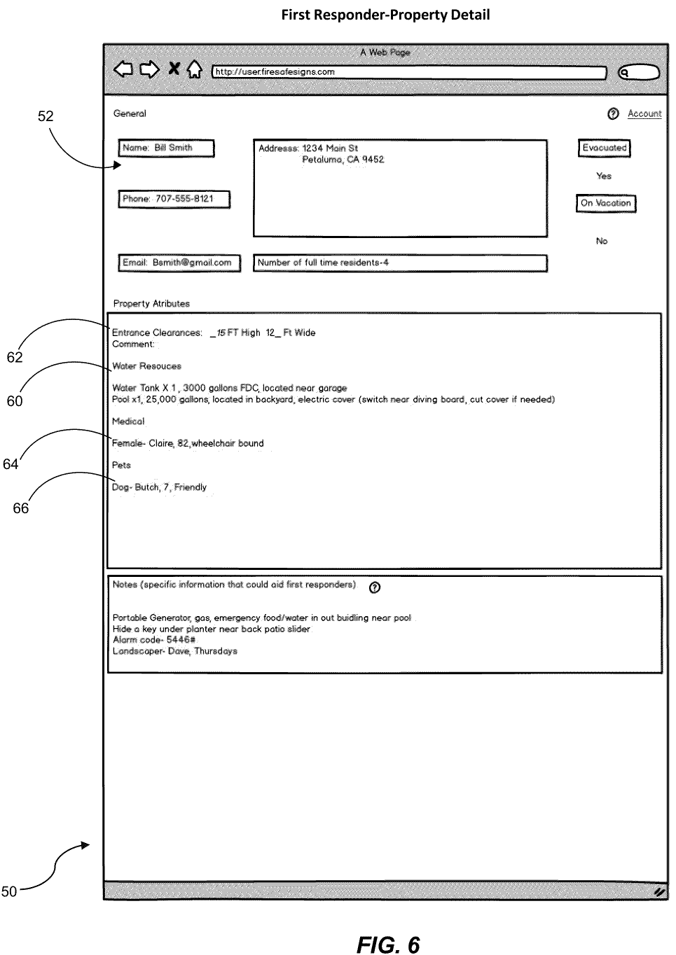

Owner Use of Provider Website: Looking next at FIG. 5, the property owner opens an account with the provider using a web application through the provider website that enables the user to interact with the provider website through a user interface, 50. The user may provide detailed information about their property, initially simply including the owner’s name, property address, and owner contact information (collectively) 52, as well as the number of residents on the property 54. An on/off button 56 provides the owner with the ability to indicate whether the property has been evacuated, and another binary option enables the owner to signify whether they are on vacation and the vacation dates 58. Specific locations of water resources can be indicated 60 and entrance clearances specified 62. Specific medical conditions for persons on the property can be indicated 64, as can pet names 66, and emergency contacts 68. The property owner can provide as much potentially relevant information as they wish in an open editable text box 70. First responders with the service provider may review the information provided by the property owner and enter further information to supplement the owner provided information [see FIG. 6].

The service provider may prepopulate popular/preformatted options to help property owners provide useful information. Access may be subscription based for homeowners and allows them to update information in real time and provides them incentives for future sign purchases and information about obtaining annual update stickers (if they pay for the subscription annually).

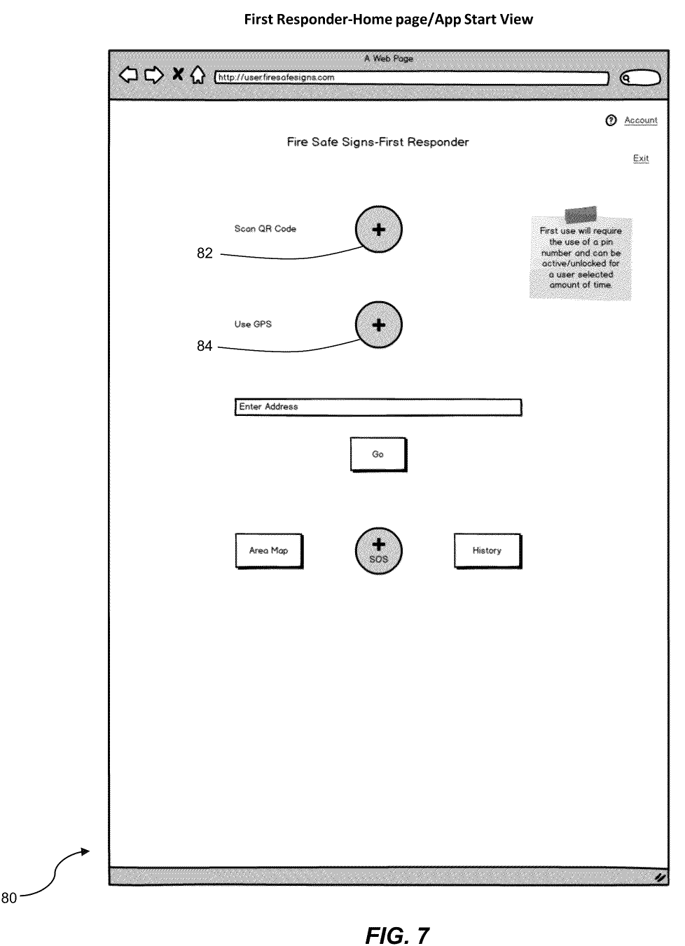

Looking next at FIG. 7, the first responder side of the system may be subscription-based as well, according to the agency/service providing the emergency response services. This may be an app-based service with graphical user interfaces 80 for first responder inputs and interactions (other versions will be available as well- QR Code direct, Web-manual input). A subscribing agency scans the QR code and pin number to gain access to the information for that specific property. Automated GPS activation may also be employed 84. The system may work with license plate readers to further speed up the process.

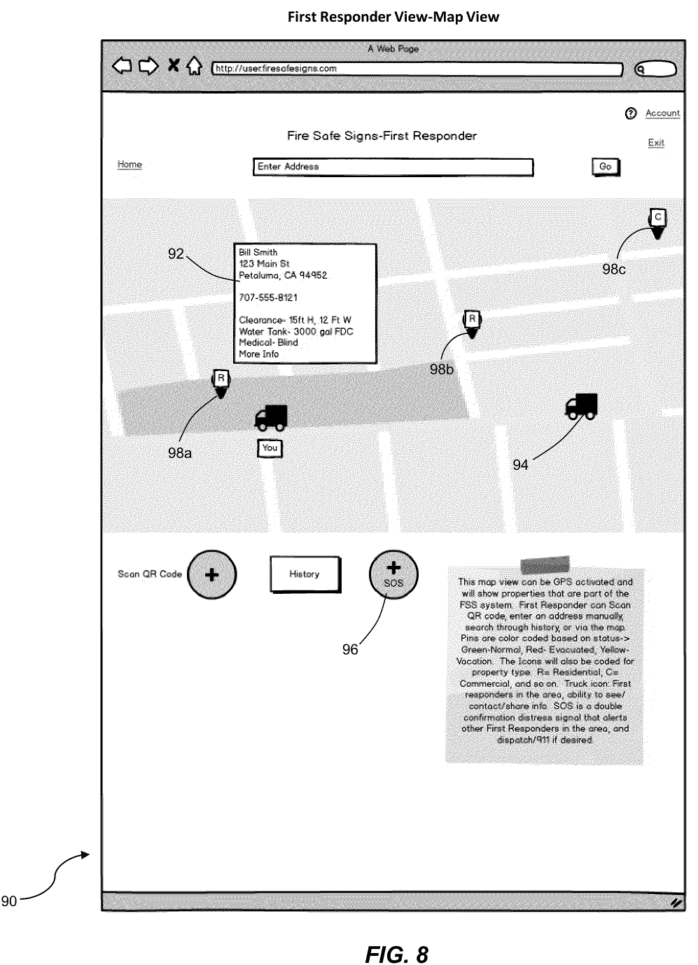

Map View/Connect/SOS: Referring next to FIG. 8, on the graphical user interface displayed on their network connectable devices, first responders will be able to see subscribing property owners in the area via a map view 90. Again, the system and the view may be automatically GPS activated. When encountering a property, a first responder may scan a QR code on a fire safe sign or enter an address manually and quickly access salient emergency information regarding the property. In this view first responders will be able to see quick information on properties as well as other first responders 94 in the area. The specific user may share property information/etc. with others in a responding group. The SOS feature 96 alerts other first responders to a first responder in distress or some other emergency. When activated the first responder’s location/situation (from a predetermined list) is shared with nearby first responders. A call to dispatch or 911 can also be initiated. Pins 98a, 98b, 98c, show properties as residential 98a, 98b, or commercial 98c, or other, and are color coded to show status, e.g., green signifying normal, red evacuated, and yellow vacation.

From the foregoing, it should be clear that fire safe signs save time and thus save lives. As a practical example, first responders routinely report having to take time to assess vehicle accessibility on a property driveway or entrance, perhaps by getting out of a vehicle and walking the road. In circumstances where every second counts, such wasted time may not merely be costly, it may be deadly. Thus, an icon showing access clearances obviates the need for a physical inspection and saves that critical time.

The same is true for the use of medical icons. First responders also must do a kind of triage, making countless decisions with less than perfect information. Medical icons enable first responders to prioritize properties with residents having special medical conditions.

Similarly for evacuation stickers. They simply enable first responders to defer addressing a particular property or to promote it only after evacuations needed nearby have first been handled.

The above disclosure is sufficient to enable one of ordinary skill in the art to practice the invention, and it further provides the best mode of practicing the invention presently contemplated by the inventor. While there is provided herein a full and complete disclosure of the preferred embodiments of this invention, the applicant does not desire to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features, alternative images or icons, or the like.

Therefore, the above description and illustrations should not be construed as limiting the scope of the invention, which is defined by the appended claims.

What is claimed as invention is:

1. A sign system to facilitate and expedite operations carried out by first responders on specific real property, comprising a sign configured for mounting on an upright surface at or near a property entrance and bearing indicia of conditions relating to that property and pertinent to operations performed by first responders.

2. The sign system of claim 1, wherein the indicia borne on said signs are a combination of numbers and symbolic icons indicating information elements selected from the group consisting of the street number of the property, emergency vehicle access clearances for a property entranceway, on-site water resources, whether a Fire Department Connection is on the property, medical condition notifications for any individuals residing at the property, site hazards, and livestock, pets, or other animals present on the property.

3. The sign system of claim 2, further including an annual renewal sticker signifying the update status of the sign indications.

4. The sign system of claim 2, further comprising a subscription-based first responder communications system, including:
a server computer having memory for storing data and information relating to subscriber properties, a processor coupled to said memory, said server configured for bidirectional communication to provide access to subscribers and first responders through an online network with network connectable devices controlled by subscribers and first responders, wherein said network connectable devices are configured to run an app with a visual display and a user interface enabling users to subscribe to said system, and for subscribers and first responders to enter and update property information for storage in said server memory.

5. The sign system of claim 4, wherein said system is administered by a business enterprise.

6. The sign system of claim 4, wherein said system is administered by a governmental agency.

7. The sign system of claim 4, wherein said signs further including a scannable secured and encrypted dynamic quick response (QR) code that provides means for first responders to scan said QR code and obtain rapid access to property information stored in said system through a network connectable device.

8. The sign system of claim 7, wherein said QR codes are incorporated into a sign icon.

9. The sign system of claim 7, wherein the information relating to the subscriber property includes confidential information selected from the group consisting of the property owner’s name, the number of residents on the property, whether the residents are on vacation, the types of medical conditions for persons on the property, pet names, emergency contact information, and whether the owners are on vacation.

10. The sign system of claim 4, further including automatic GPS activation operational on first responder network connectable devices.

11. The sign system of claim 4, wherein said network connectable devices of first responders are configured with a graphical user interface to visually display subscriber properties on a map with icons showing other first responders in the area and the evacuation status of nearby properties owned by subscribers.

12. The sign system of claim 11, further including an SOS feature enabling first responders to use the system to communicate to other first responders that they are in distress and to have their situation and location indicated on maps shown on other nearby first responder network connectable devices.

13. The sign system of claim 12, wherein subscriber properties displayed on a map are symbols indicating whether the property is residential or commercial and whether the occupants are on site, evacuated, or on vacation.

14. The sign system of claim 1, further including an adhesive and removable evacuation notification sticker to signify when residents have evacuated a property.
